(19) United States
(12) Patent Application Publication
(10) Pub. No.: US 2016/0194530 A1
(43) Pub. Date: Jul. 7, 2016

(54) POLYMERIZABLE ADHESIVE THAT FORMS METHACRYLATE IPN

(71) Applicant: E. I. DU PONT DE NEMOURS AND COMPANY, Wilmington, DE (US)

(72) Inventors: David Gordon Halterman, Tonawanda, NY (US); Clyde Spencer Hutchins, Colden, NY (US); Keith William Pollak, Lewiston, NY (US)

(21) Appl. No.: 14/909,797

(22) PCT Filed: Aug. 11, 2014
(86) PCT No.: PCT/US14/50491

§ 371 Date: Feb. 3, 2016

Related U.S. Application Data
(60) Provisional application No. 61/865,184, filed on Aug. 13, 2013.

(51) Int. Cl. C09J 133/20

(52) U.S. Cl. CPC C09J 133/20; C08K 3/22

(57) ABSTRACT

A polymerizable adhesive composition that forms an interpenetrating network when the components are polymerized. A sirup is made with a styrenic prepolymer, (meth)acrylate monomer and multifunctional (meth)acrylate crosslinking agent. The adhesive composition afforded by this sirup is polymerized in place using a conventional free radical initiators and activators. The adhesive is found especially useful as a joint adhesive for solid surface materials.

### FIELD OF THE INVENTION

The invention relates to a polymerizable adhesive composition that forms an interpenetrating network when the components are polymerized.

### BACKGROUND OF THE INVENTION

Solid surface materials are often joined together to form larger articles (e.g. longer or wider sheets). Joint adhesive is currently used to accomplish this seaming task. The tensile strength of typical solid surface materials is about 48 MPa. The joint strength using a typical, two-part acrylic, joint adhesive such as DuPont Joint Adhesive—Translucent White is about 30 MPa. As the joint strength is weaker than the solid surface material, it will limit the utility of the seamed larger article. Other joint adhesive formulations have employed mineral fillers with varying particle size and particle size distributions, the use of performance additives such as adhesion promoting monomers, various combinations and types of crosslinking agents in order to achieve stronger joints. These other formulations also form joints that are weaker than the solid surface material. There is a need for an adhesive with a tensile strength similar to solid surface materials.

### SUMMARY OF THE INVENTION

The present invention is a polymerizable adhesive comprising a styrenic copolymer that is soluble in a methacrylate monomer, a (meth)acrylate monomer, and a multifunctional (meth)acrylate crosslinking agent wherein an interpenetrating network is formed when the components are polymerized.

The polymerizable adhesive of the present invention has use for general purpose adhesion of materials, but is found to be especially useful in the field of solid surface joint adhesives for materials based on acrylate or methacrylate monomers. Another embodiment of the invention is a countertop comprising two or more solid surface materials joined with a polymerizable adhesive comprising a styrenic copolymer that is soluble in a methacrylate monomer, a (meth)acrylate monomer, and a multifunctional (meth)acrylate crosslinking agent wherein an interpenetrating network is formed when the components are polymerized.

A further embodiment of the invention is a polymerizable adhesive comprising a styrenic copolymer that is soluble in a methacrylate monomer, a (meth)acrylate monomer, and a multifunctional (meth)acrylate crosslinking agent, and optional filler or adhesion-promoting (meth)acrylate monomer, wherein an interpenetrating network is formed when the components are polymerized; and a countertop joined with the polymerizable adhesive.

### DEFINITIONS

The term “interpenetrating polymer network (IPN)” is used herein to refer to a class of materials that are combinations of two or more polymers in network form that are synthesized in juxtaposition. Interpenetrating polymer network is an intimate blend of two or more polymers that are sufficiently hindered from spinodal decomposition. This hindrance is afforded by chemical crosslinks and/or physical entanglements.

The term “Sequential IPN” is used herein to refer to a type of IPN formed from a pre-existing polymer dissolved in a solution of monomer plus cross-linker, initiator and any activators and polymerized in situ. The sequential IPNs include many possible materials where the synthesis of one network follows the other.

The term “Simultaneous interpenetrating network (SIN)” is used herein to refer to a type of IPN formed from monomers or prepolymers plus cross-linkers, initiators and any activators for all networks mixed, and the polymerizing reactions are carried out simultaneously but by noninterfering reactions.

The term “Thermoplastic IPN” is used herein to refer to a type of IPN that is hybrid between polymer blends and IPNs that involve physical entanglements rather than chemical cross-links. Thus, these materials flow at elevated temperatures, and at use temperature, they are cross-linked and behave like IPNs.

The term “Semi-IPN” is used herein to refer to a type of IPN in which one or more polymers are cross-linked and one or more polymers are linear or branched.

The term “styrenic copolymer” is used herein to refer to any copolymer of styrene and another comonomer, typically containing some a chemical functional group, such as a cyano group or an anhydride.

The term “solid surface material” is used herein to refer to its normal meaning and represents a uniform, non-gel coated, non-porous, three dimensional solid material containing polymer resin and particulate filler, such material being particularly useful in the building trades for kitchen countertops, sinks and wall coverings wherein both functionality and an attractive appearance are necessary.

### DETAILED DESCRIPTION

The polymerizable adhesive of the present invention has use for general purpose adhesion of materials, but is found to be especially useful in the field of solid surface joint adhesives for materials based on acrylate or methacrylate monomers. Joint adhesives are a good alternative to other mechanical techniques for joining two materials together because the applied load is more evenly distributed over the entire seam than when mechanical fasteners are used. In addition, the use of joint adhesives often makes it possible to work more rapidly, and also has the advantage of better appearance. Joint adhesives are usually formed from two components: Component A which contains polymerizable monomers, such as acrylate or methacrylate esters, multifunctional (meth)acrylate ester crosslinkers, and optional fillers, and a Component B which contains a free radical initiator for curing and setting the mixed adhesive composition. These two components are usually stored in in two different compartments and are mixed at the time of application of the joint adhesive. The initiator is typically based on Dibenzoyl Peroxide, and is well known in the art. Component A containing the polymerizable monomers typically also contains other ingredients such as a cure accelerators, rheology modifiers, adhesion promoters, and UV absorbers. The cure accelerator serves to hasten polymerization and hardening of the joint adhesive mixture when the two components are mixed at time of application. The use of tertiary amines such as dimethyl-para-toluidine, or 2,2′-(p-tolylimino)diethanol is well known in the art.

The polymerizable adhesive of the present invention forms an interpenetrating polymer network. In general, an Interpenetrating polymer network is an intimate blend of two or more polymers that are sufficiently hindered from spinodal decomposition. This hindrance is typically afforded by chemical crosslinks and/or physical entanglements. Three classes of interpenetrating networks are described herein. They are characterized by the degree of crosslinking in each of the polymer components. The classes are interpenetrating polymer network (IPN), semi-interpenetrating polymer network (Semi-IPN), and thermoplastic interpenetrating polymer network (Thermoplastic IPN).

Two processes for creating the classes of IPN's are described. They are characterized by the sequence in which each polymer component is formed. The two processes are known as simultaneous and sequential. Simultaneous interpenetrating networks (SIN) are formed from monomers or prepolymers plus cross-linkers, initiators and any activators for all networks mixed, and the polymerizing reactions are carried out simultaneously but by noninterfering reactions. Sequential IPNs are formed from a pre-existing polymer dissolved in a solution of monomer plus cross-linker, initiator and any activators and polymerized in situ. The sequential IPNs include many possible materials where the synthesis of one network follows the other.

The interpenetrating polymer network formed by the polymerizable adhesive of the present invention is an intimate blend of two or more polymers that are sufficiently hindered from spinodal decomposition. This hindrance is afforded by chemical crosslinks and/or physical entanglements. Spinodal decomposition is essentially a mechanism for the rapid unmixing of a mixture of liquids or solids. From a practical standpoint, the interpenetrating network provides a means of producing and setting a very finely dispersed microstructure that can significantly enhance the physical properties of the material.

The problems of the prior art have been overcome by the embodiments disclosed herein, which include a polymerizable adhesive comprising a styrenic copolymer that is soluble in a (meth)acrylate monomer and a multifunctional (meth)acrylate crosslinking agent wherein an interpenetrating network is formed when the components are polymerized. In another embodiment the polymerizable adhesive includes optional filler. In another embodiment the polymerizable adhesive includes optional functional performance additives such as adhesion promoting (meth)acrylate monomers, rheology control agents, and UV absorbers and stabilizers.

The polymerizable adhesive composition includes a pre-existing polymer (prepolymer) that is soluble in a (meth)acrylate monomer. The prepolymer is a linear, branched or networked styrenic copolymer. The styrenic copolymer is a glassy polymer that has pendant functionality which will aid in the adhesion of the polymerizable adhesive composition to other materials. An example of a useful prepolymer is Lustran 29 (made by INEOS ABS (USA) Corporation), which is a copolymer of Styrene and Acrylonitrile. Another example of a useful prepolymer is Dylark® 232 which is a copolymer of Styrene and Maleic Anhydride available from Nova Chemicals.

The polymerizable adhesive composition also includes a polymerizable (meth)acrylate monomer. A preferred methacrylate monomer is methyl methacrylate (MMA).

The polymerizable adhesive composition includes a multifunctional (meth)acrylate crosslinking agent. A preferred class of crosslinking agents is the (meth)acrylate esters of polyols. Some representative examples include ethylene glycol di(meth)acrylate, neopentyl glycol di(meth)acrylate, hexanediol di(meth)acrylate, trimethylolpropane tri(meth)acrylate, pentaerythritol tri(meth)acrylate, dipentaerythritol tetra(meth)acrylate, and the like. Other suitable types of crosslinking agents include divinyl compounds, such as divinyl ethers, allyl (meth)acrylate, urethane di- and poly-(meth)acrylates.

A sirup is made with the styrenic prepolymer, (meth)acrylate monomer and multifunctional (meth)acrylate crosslinking agent. The adhesive composition afforded by this sirup is polymerized in place using a conventional free radical initiators and activators (i.e. Dibenzoyl Peroxide (BPO)/Toluidine (N,N-Bis(2-hydroxyethyl)-p-Toluidine redox couple). Without being bound by theory, it is believed that the polymerizing/crosslinking monomers form a thermosetting semi interpenetrating network (Semi-IPN) around the styrenic prepolymer. It is found that formation of an IPN is desirable in order to obtain the required adhesive properties as without the formation of an IPN, the polymeric components are immiscible and the composition may phase separate into large domains of one polymer or the other. Such gross phase separation of polymer blends typically results in a material with poor mechanical properties. Although the extent of crosslinking can be determined by methods known in the art, such as the swelling method, NMR or microscopic techniques, it is not necessary to know the actual cross-linking density. The extent of cross-linking is chosen based upon desired polymer network flexibility and rigidity. Higher crosslinking densities result in less flexible adhesives.

The preferred joint adhesive composition is based upon the use of highly MMA soluble, linear styrene-acrylonitrile (SAN) copolymers to enhance adhesion by virtue of pendant nitrile functionality positioned and trapped within a thermosetting Semi-IPN polymer network. In the “un-cured” fluid state the SAN copolymer is miscible in the acrylic monomer/crosslinker mixture. As the acrylic network is formed during the course of the polymerization, the SAN copolymer becomes immiscible and begins to undergo separation into two phases. The polymerizing/crosslinkable monomers used in the adhesive formulation create a thermosetting semi-interpenetrating network (Semi-IPN) where the MMA based crosslinking network essentially surrounds and entraps the linear styrene-acrylonitrile (SAN) copolymer chains thus limiting the both the rate of phase separation of the two glassy polymers and also restricting the size of the domains of the phase separated Semi-IPN system both of these features may be important in controlling the morphology of the resulting Semi-IPN joint adhesive system. The morphology of the semi-IPN may be an important factor in contributing to the adhesion of the system to the solid surface adherend and thereby to the improved strength of the joint adhesive.

The polymerizable adhesive composition optionally includes particulate mineral filler. In general, this filler increases the hardness, stiffness or fracture toughness of the adhesive relative to the unfilled polymer or combination of unfilled polymers forming the Semi-IPN It will be understood, that in addition, the mineral filler can provide other attributes to the final article. For example, it can provide other functional properties, such as flame retardant, or it may serve a decorative purpose and modify the aesthetics. Some representative fillers include alumina, alumina trihydrate (ATH), alumina monohydrate, aluminum hydroxide, aluminum oxide, aluminum sulfate, aluminum phosphate, aluminum silicate, Bayer hydrate, borosilicates, calcium sulfate, calcium silicate, calcium phosphate, calcium carbonate, calcium hydroxide, calcium oxide, apatite, glass bubbles, glass microspheres, glass fibers, glass beads, glass flakes, glass powder, glass spheres, barium carbonate, barium hydroxide, barium oxide, barium sulfate, barium phosphate, barium silicate, magnesium sulfate, magnesium silicate, magnesium phosphate, magnesium hydroxide, magnesium oxide, kaolin, montmorillonite, bentonite, pyrophyllite, mica, gypsum, silica (including sand), ceramic microspheres and ceramic particles, powder talc, titanium dioxide, diatomaceous earth, wood flour, borax, or combinations thereof. The filler is present in the form of small particles, with an average particle size in the range of from about 1-500 microns. A preferred range is an average particle size in the range of from about 3-75 microns, and more preferably in the range of 3-15 microns. Furthermore, the fillers can be optionally coat-treated with coupling agents, such as A-174 (γ-Methacryloxypropyl Trimethoxysilane; Silquest® A-174 from Momentive) ATH is often a preferred filler for poly(methylmethacrylate) (PMMA) systems because the refractive indexes of the two materials are similar.

Optionally, the polymerizable mixture of styrene/acrylonitrile prepolymer, (meth)acrylate monomers, and multifunctional (meth)acrylate crosslinking agents may also contain functional (meth)acrylate monomers that can enhance performance of the adhesive. Common functional (meth)acrylic monomers improve the adhesion of the Semi-IPN thermosetting polymer network to the optional mineral fillers (i.e. γ-Methacryloxypropyl Trimethoxysilane; Silquest® A-174 from Momentive). The polymerizable mixtures optionally may also contain rheology control agents (i.e. a fumed Silica such as Cab-O-Sil® TS-720 fumed silica from Cabot) in order to modify the fluid flow characteristics of the uncured joint adhesive.

### EXAMPLES

### Comparative Example

### Two Part (10:1) Commercial Dupont™ Joint Adhesive—Translucent White All—Acrylic Based Component A with Dibenzoyl Peroxide (BPO) Based Component B

Preparation of an Adhesive Butt Joint for Mechanical Testing—

Corian® Bisque (DuPont) was used as the substrate (adherend) for butt joint uniaxial tensile testing. The butt joint was prepared using the general protocol as outlined in ASTM D1002. The Corian® surface was prepared according to ASTM D2093 using 150 grit sandpaper followed by a methanol solvent wipe. Following procedures outlined in D1002, an adhesive test panel is prepared by aligning two pieces of Corian® Bisque material (280 mm×114 mm×12 mm) side-by-side with approximately a 6-10 mm gap between them. The open gap was fitted with a 10 mil spacer in order to uniformly control the gap width of the adhesive joint. The gap was also fitted with a 10 mil twisted pair J-type thermocouple in order to measure the set time of the adhesive butt joint. The commercially available DuPont™ Joint Adhesive—Translucent White (TW) is dispensed within the gap and the two pieces of Corian® are moved together, clamped and held in place for about 30-60 minutes or until adequate handling strength is developed by the test panel. The test panel is conditioned at 140° C. for one hour and then cut into six narrow tensile test specimens. The rectangular test specimens are then milled into tensile bars according to ASTM D638. The set time of the adhesive butt joint was measured as 18 minutes using the time-temperature data provided by the thermocouple embedded within the adhesive joint. The tensile strength (Ultimate Stress) of the butt joint was 29.8 MPa with a tensile elongation (Ultimate Strain) of 0.36%. The tensile strength of Corian® Bisque is typically measured at about 48 MPa with a tensile elongation of about 0.95%.

Preparation of a Bulk Adhesive Test Specimen for Color and Hardness Testing—

The remaining adhesive that was not used to prepare the butt joint is dispensed into a small mold (75 mm×75 mm×18 mm) equipped with a J-Type thermocouple and allowed to cure. The time-to-peak for the adhesive puck was 12.9 minutes and the small casting reached a peak temperature of 139° C. The indentation hardness (Rockwell M Scale) was measured as 55. The CIE color was measured as L*=83.7, a*=−2.40, and b*=+7.10 using a Hunter MiniScan® EZ.

This is a comparative example detailing the characteristics of a commercial Translucent White (i.e. non-pigmented) DuPont™ Joint Adhesive.

### Example 1

### Two Part (10:1) Semi-IPN Joint Adhesive (15 Micron ATH Filler) (Non-Pigmented) Styrene/Acrylonitrile Copolymer (SAN) Based Component A with Dibenzoyl Peroxide (BPO) Based Component B

Preparation of Component A—

A 500 mL reaction kettle (˜10 cm×15 cm) having a ground glass fitting was assembled with a reaction kettle top (with a ground glass fitting) having ports for an air-driven mechanical stirrer and an Allihn® type reflux condenser. The following ingredients were sequentially weighed into the reaction kettle:
Prepolymer Sirup (27.5% Solution of Lustran® 29 dissolved in Methyl Methacrylate) 147 g
TRIM (Trimethylolpropane Trimethacrylate; SR-350 from Sartomer) 4.63 g
A-174 (γ-Methacryloxypropyl Trimethoxysilane; Silquest® A-174 from Momentive) 4.63 g
Tinuvin® P (2-(2H-benzotriazol-2-yl)-p-Cresol from BASF) 0.34 g
Toluidine (N,N-Bis(2-hydroxyethyl)-p-Toluidine from Sigma-Aldrich 0.57 g

The mixture was stirred using a four-blade stainless steel propeller (60 mm diameter with four 30° pitched blades) at 1200 rpm for about one minute. A pre-mixed blend of 68.3 g Aluminum Trihydroxide (Chalco H-WF-15 ATH) and 2.28 g fumed silica (Cab-O-Sil® TS-720 from Cabot) was then added portion wise over a one minute interval. After the addition of the ATH/fumed silica blend was complete, mixing continued for an additional 2-3 minutes. The mixture was slowly evacuated (Reflux condenser cooled to −10 deg C.) to 75 Torr (about 27 inches of Hg) over one minute with continued stirring at ˜1200 rpm. The vacuum was released with air and approximately a 125 g aliquot was withdrawn for measurement of Brookfield Viscosity. The Brookfield Viscosity (RVDVI-Prime; vane spindle #73; at 25° C.) was 20,660 cps at 1 rpm and 14,460 cps at 10 rpm. The thixo ratio (cps @ 1 rpm/10 rpm) was calculated as 1.4.

Preparation of Component B—

A 500 mL reaction kettle (˜10 cm×15 cm) having a ground glass fitting was assembled with a reaction kettle top (with a ground glass fitting) having ports for an air-driven mechanical stirrer and an Allihn® type reflux condenser. The following ingredients were sequentially weighed into the reaction kettle:
DPGDB (Dipropyleneglycol Dibenzoate from Sigma-Aldrich) 25.6 g
Luperox® A98 (75% Dibenzoyl Peroxide in Water from Arkema) 0.91 g
TS-720 (Cab-O-Sil® TS-720 fumed silica from Cabot) 0.82 g

The above mixture was stirred using a four-blade stainless steel propeller (60 mm diameter with four 30° pitched blades) at 1200 rpm for about one minute. The mixture was slowly evacuated (Reflux condenser cooled to −10 deg C.) to 75 Torr (about 27 inches of Hg) over one minute with continued stirring at ˜1200 rpm. The vacuum was released with air and a 125 g aliquot was withdrawn for measurement of Brookfield Viscosity. The Brookfield Viscosity (RVDVI-Prime; vane spindle #73; at 25° C.) was 69,000 cps at 1 rpm and 9,580 cps at 10 rpm. The thixo ratio (cps@1 rpm/cps@10 rpm) was calculated as ˜7.2.

Preparation of Two-Part Adhesive—

Component A (227.8 g) was charged to a small disposable plastic cup (PE, 16 oz). Component B (22.2 g) was added in a weight ratio of about 1:10 and the resulting mixture is gently mixed with a wooden tongue depressor. Prior to dispensing the adhesive mixture into a test joint, the adhesive containing components A and B was slowly evacuated (Reflux condenser cooled to −10 deg C.) to 75 Torr (about 27 inches of Hg) over one minute with continued stirring at ˜1200 rpm by placing the disposable plastic cup inside of a 500 mL reaction kettle.

Preparation of an Adhesive Butt Joint for Mechanical Testing—

Corian® Bisque solid surface sheeting (from DuPont) was used as the substrate (adherend) for butt joint uniaxial tensile testing. The butt joint was prepared using the protocol as outlined in ASTM D1002. The adherend was prepared according to ASTM D2093 using 150 grit sandpaper followed by a methanol solvent wipe. Following procedures outlined in D1002, an adhesive test panel was prepared by aligning two pieces of Corian® Bisque material (280 mm×114 mm×12 mm) side-by-side with approximately a 6-10 mm gap between them. The open gap was fitted with a 10 mil spacer in order to uniformly control the gap width of the adhesive joint. The gap was also fitted with a 10 mil twisted pair J-type thermocouple in order to measure the set time of the adhesive butt joint. The de-gassed adhesive is dispensed within the gap and the two pieces of Corian® were moved together, clamped and held in place for about 30 minutes (until adequate handling strength was developed). The adherend was conditioned at 1400 C for one hour and then cut into six narrow tensile test specimens. The rectangular test specimens were then milled into tensile bars according to ASTM D638. The set time of the adhesive butt joint was measured at 28 minutes using the time-temperature data provided by the thermocouple embedded within the adhesive joint. The tensile strength (Ultimate Stress) of the butt joint was 42.0 MPa with a tensile elongation (Ultimate Strain) of 0.61%. The modulus was measured as 9.2 GPa. The tensile strength of Corian® Bisque solid surface material without any joint is known to be about 48 MPa with a tensile elongation of about 0.95%.

Preparation of a Bulk Adhesive Test Specimen for Color and Hardness Testing—

The remaining adhesive that was not used to prepare the butt joint was poured into a small mold (75 mm×75 mm×18 mm) equipped with a J-Type thermocouple and allowed to cure to form a test puck. The time-to-peak for the test puck was 17.3 minutes and the small casting reached a peak temperature of 140° C. The indentation hardness (Rockwell M Scale) was measured as 51. The CIE color was measured as L*=89.2, a*=−1.60, and b*=−0.79 using a Hunter MiniScan® EZ.

This example shows superior strength and elongation relative to control joint adhesive when using an ATH filler and particle size that is similar to the control.

### Example 2

### Two Part (10:1) Semi-IPN Joint Adhesive (No Filler) (Non-Pigmented) Styrene/Acrylonitrile Copolymer (SAN) Based Component A with Dibenzoyl Peroxide (BPO) Based Component B

Preparation of Component A—

A 500 mL reaction kettle (˜10 cm×15 cm) having a ground glass fitting was assembled with a reaction kettle top (with a ground glass fitting) having ports for an air-driven mechanical stirrer and an Allihn® type reflux condenser. The following ingredients were sequentially weighed into the reaction kettle:
Prepolymer Sirup (27.5% Solution of Lustran® 29 dissolved in Methyl Methacrylate) 182 g
TRIM (Trimethylolpropane Trimethacrylate; SR-350 from Sartomer) 5.73 g
A-174 (γ-Methacryloxypropyl Trimethoxysilane; Silquest® A-174 from Momentive) 5.73 g
Tinuvin® P (2-(2H-benzotriazol-2-yl)-p-Cresol from BASF) 0.30 g
Toluidine (N,N-Bis(2-hydroxyethyl)-p-Toluidine from Sigma-Aldrich) 0.50 g

The mixture was stirred using a four-blade stainless steel propeller (60 mm diameter with four 30° pitched blades) at 1200 rpm for about one minute. 6.00 g fumed silica (Cab-O-Sil® TS-720 from Cabot) was then added portion wise over a one minute interval. After the addition of the fumed silica is complete, mixing continued for an additional 2-3 minutes. The mixture was slowly evacuated (Reflux condenser cooled to −10 deg C.) to 75 Torr (about 27 inches of Hg) over one minute with continued stirring at ˜1200 rpm. The vacuum was released with air and a 125 g aliquot was withdrawn for measurement of Brookfield Viscosity. The Brookfield Viscosity (RVDVI-Prime; vane spindle #73; at 25° C.) was 42,800 cps at 1 rpm and 14,230 cps at 10 rpm. The thixo ratio (cps @ 1 rpm/10 rpm) was calculated as ˜3.0.

Preparation of Component B—

A 500 mL reaction kettle (˜10 cm×15 cm) having a ground glass fitting was assembled with a reaction kettle top (with a ground glass fitting) having ports for an air-driven mechanical stirrer and an Allihn® type reflux condenser. The following ingredients were sequentially weighed into the reaction kettle:
DPGDB (Dipropyleneglycol Dibenzoate from Sigma-Aldrich) 93.7 g
Luperox® A98 (75% Dibenzoyl Peroxide in Water from Arkema) 3.33 g
TS-720 (Cab-O-Sil® TS-720 fumed silica from Cabot) 3.00 g

The above mixture was stirred using a four-blade stainless steel propeller (60 mm diameter with four 30° pitched blades) at 1200 rpm for about one minute. The stirred mixture was slowly evacuated (Reflux condenser cooled to −10 deg C.) to 75 Torr (about 27 inches of Hg) over one minute with continued stirring at ˜1200 rpm. The vacuum was released with air and a 125 g aliquot was withdrawn for measurement of Brookfield Viscosity. The Brookfield Viscosity (RVDVI-Prime; vane spindle #73; at 25° C.) was 43,870 cps at 1 rpm and 6630 cps at 10 rpm. The thixo ratio (cps@1 rpm/cps@10 rpm) was calculated as ˜6.6.

Preparation of Two-Part Adhesive—

Component A (200 g) was charged to a small disposable plastic cup (PE, 16 oz). Component B (20.0 g) was added in a weight ratio of about 1:10 and the resulting mixture is gently mixed with a wooden tongue depressor. Prior to dispensing the adhesive mixture into a test joint, the adhesive containing components A and B was slowly evacuated (Reflux condenser cooled to −10 deg C.) to 75 Torr (about 27 inches of Hg) over one minute with continued stirring at ˜1200 rpm by placing the disposable plastic cup inside of a 500 mL reaction kettle. The evacuated mixture comprising components A and B was optically clear.

Preparation of an Adhesive Butt Joint for Mechanical Testing—

Corian® Bisque solid surface sheet (from DuPont) was used as the substrate (adherend) for butt joint uniaxial tensile testing. The butt joint was prepared using the general protocol as outlined in ASTM D1002. The adherend was prepared according to ASTM D2093 using 150 grit sandpaper followed by a methanol solvent wipe. Following procedures outlined in D1002, an adhesive test panel is prepared by aligning two pieces of Corian® Bisque material (280 mm×114 mm×12 mm) side-by-side with approximately a 6-10 mm gap between them. The open gap was fitted with a 10 mil spacer in order to uniformly control the gap width of the adhesive joint. The gap was also fitted with a 10 mil twisted pair J-type thermocouple in order to measure the set time of the adhesive butt joint. The de-gassed adhesive was dispensed within the gap and the two pieces of Corian® moved together, clamped and held in place for about 30 minutes (until adequate handling strength was developed). The adherend was conditioned at 140° C. for one hour and then cut into six narrow tensile test specimens. The rectangular test specimens were then milled into tensile bars according to ASTM D638. The set time of the adhesive butt joint was measured at 35.5 minutes using the time-temperature data provided by the thermocouple embedded within the adhesive joint. The tensile strength (Ultimate Stress) of the butt joint was 45.9 MPa with a tensile elongation (Ultimate Strain) of 0.74%. The modulus was measured as 8.9 GPa. The tensile strength of Corian® Bisque is known to be about 48 MPa with a tensile elongation of about 0.95%.

Preparation of a Bulk Adhesive Test Specimen for Color and Hardness Testing—

The remaining adhesive that was not used to prepare the butt joint was poured into a small mold (75 mm×75 mm×18 mm) equipped with a J-Type thermocouple and allowed to cure to form a test puck. The time-to-peak for the adhesive puck was 19.1 minutes and the test puck reached a peak temperature of 146° C. The indentation hardness (Rockwell M Scale) was measured at 46. The CIE color was measured as L*=90.0, a*=−1.50, and b*=−2.50 using a Hunter MiniScan® EZ. The polymerized adhesive composition appeared optically translucent but no longer transparent as was the uncured joint adhesive mixture.

This example shows superior Strength and Elongation even when no filler is used. The joint stiffness (modulus) is lower than joints prepared with joint adhesives that have fillers and thus demonstrates the value of filler with respect to increased modulus. The observation that the joint adhesive mixture is optically clear before polymerization and opaque after polymerization shows that the two polymers forming the semi-IPN are incompatible with one another, however the semi-IPN architecture limits the phase separation that can occur.

### Example 3

### Two Part (10:1) Semi-IPN Joint Adhesive (9 Micron ATH Filler) (Non-Pigmented) Styrene/Acrylonitrile Copolymer (SAN) Based Component A with Dibenzoyl Peroxide (BPO) Based Component B

Preparation of Component A—

A 500 mL reaction kettle (˜10 cm×15 cm) having a ground glass fitting was assembled with a reaction kettle top (with a ground glass fitting) having ports for an air-driven mechanical stirrer and an Allihn® type reflux condenser. The following ingredients were sequentially weighed into the reaction kettle:
Prepolymer Sirup (27.5% Solution of Lustran® 29 dissolved in Methyl Methacrylate) 176 g
TRIM (Trimethylolpropane Trimethacrylate; SR-350 from Sartomer) 5.55 g
A-174 (γ-Methacryloxypropyl Trimethoxysilane; Silquest® A-174 from Momentive) 5.55 g
Tinuvin® P (2-(2H-benzotriazol-2-yl)-p-Cresol from BASF) 0.41 g
Toluidine (N,N-Bis(2-hydroxyethyl)-p-Toluidine from Sigma-Aldrich) 0.68 g

The mixture was stirred using a four-blade stainless steel propeller (60 mm diameter with four 30° pitched blades) at 1200 rpm for about one minute. A pre-mixed blend of 81.8 g Aluminum Trihydroxide (OE-431 ATH from Huber Engineered Materials) and 2.73 g fumed silica (Cab-O-Sil® TS-720 from Cabot) was then added portion wise over a one minute interval. After the addition of the ATH/fumed silica blend is complete, mixing continued for an additional 2-3 minutes. The mixture was slowly evacuated (Reflux condenser cooled to −10 deg C.) to 75 Torr (about 27 inches of Hg) over one minute with continued stirring at ˜1200 rpm. The vacuum was released with air and approximately a 125 g aliquot is withdrawn for measurement of Brookfield Viscosity. The Brookfield Viscosity (RVDVI-Prime; vane spindle #73; at 25° C.) was 20,660 cps at 1 rpm and 14,460 cps at 10 rpm. The thixo ratio (cps @ 1 rpm/10 rpm) was calculated as ˜1.4.

Preparation of Component B—

A 500 mL reaction kettle (˜10 cm×15 cm) having a ground glass fitting was assembled with a reaction kettle top (with a ground glass fitting) having ports for an air-driven mechanical stirrer and an Allihn® type reflux condenser. The following ingredients were sequentially weighed into the reaction kettle:
DPGDB (Dipropyleneglycol Dibenzoate from Sigma-Aldrich) 25.6 g
Luperox® A98 (75% Dibenzoyl Peroxide in Water from Arkema) 0.91 g
TS-720 (Cab-O-Sil® TS-720 fumed silica from Cabot) 0.82 g

The above mixture was stirred using a four-blade stainless steel propeller (60 mm diameter with four 30° pitched blades) at 1200 rpm for about one minute. The mixture was slowly evacuated (Reflux condenser cooled to −10 deg C.) to 75 Torr (about 27 inches of Hg) over one minute with continued stirring at ˜1200 rpm. The vacuum was released with air and a 125 g aliquot was withdrawn for measurement of Brookfield Viscosity. The Brookfield Viscosity (RVDVI-Prime; vane spindle #73; at 25° C.) was 69,000 cps at 1 rpm and 9,580 cps at 10 rpm. The thixo ratio (cps@1 rpm/cps@10 rpm) was calculated as ˜7.2.

Preparation of Two-Part Adhesive—

Component A (227.8 g) was charged to a small disposable plastic cup (PE, 16 oz). Component B (22.2 g) was added in a weight ratio of about 1:10 and the resulting mixture was gently mixed with a wooden tongue depressor. Prior to dispensing the adhesive mixture into a test joint, the adhesive containing components A and B was slowly evacuated (Reflux condenser cooled to −10 deg C.) to 75 Torr (about 27 inches of Hg) over one minute with continued stirring at ˜1200 rpm by placing the disposable plastic cup inside of a 500 mL reaction kettle.

Preparation of an Adhesive Butt Joint for Mechanical Testing—

Corian® Bisque solid surface sheet (from DuPont) was used as the substrate (adherend) for butt joint uniaxial tensile testing. The butt joint was prepared using the protocol as outlined in ASTM D1002. The adherend was prepared according to ASTM D2093 using 150 grit sandpaper followed by a methanol solvent wipe. Following procedures outlined in D1002, an adhesive test panel is prepared by aligning two pieces of Corian® Bisque material (280 mm×114 mm×12 mm) side-by-side with approximately a 6-10 mm gap between them. The open gap was fitted with a 10 mil spacer in order to uniformly control the gap width of the adhesive joint. The gap was also fitted with a 10 mil twisted pair J-type thermocouple in order to measure the set time of the adhesive butt joint. The de-gassed adhesive is dispensed within the gap and the two pieces of Corian® were moved together, clamped and held in place for about 30 minutes (until adequate handling strength was developed). The adherend was conditioned at 140° C. for one hour and then cut into six narrow tensile test specimens. The rectangular test specimens were then milled into tensile bars according to ASTM D638. The set time of the adhesive butt joint was measured at 19.0 minutes using the time-temperature data provided by the thermocouple embedded within the adhesive joint. The tensile strength (Ultimate Stress) of the butt joint was 47.7 MPa with a tensile elongation (Ultimate Strain) of 0.82%. The modulus was measured as 9.2 GPa. The tensile strength of Corian® Bisque solid surface material without any joint is known to be about 48 MPa with a tensile elongation of about 0.95%.

Preparation of a Bulk Adhesive Test Specimen for Color and Hardness Testing—

The remaining adhesive that was not used to prepare the butt joint was poured into a small mold (75 mm×75 mm×18 mm) equipped with a J-Type thermocouple and allowed to cure. The time-to-peak for the adhesive puck was 12.7 minutes and the small casting reached a peak temperature of 135° C. The indentation hardness (Rockwell M Scale) was measured as 60. The CIE color was measured as L*=89.1, a*=−1.39, and b*=−0.43 using a Hunter MiniScan® EZ.

This example is an embodiment of the preferred joint adhesive composition both from a strength and elongation perspective but also from an aesthetic perspective.

### Example 4

### Two Part (10:1) Semi-IPN Based Joint Adhesive (75 Micron ATH Filler) Styrene/Acrylonitrile Copolymer (SAN) Based Component a with Dibenzoyl Peroxide (BPO) Based Component B

Preparation of Component A—

A 500 mL reaction kettle (˜10 cm×15 cm) having a ground glass fitting was assembled with a reaction kettle top (with a ground glass fitting) having ports for an air-driven mechanical stirrer and an Allihn® type reflux condenser. The following ingredients were sequentially weighed into the reaction kettle:
Prepolymer Sirup (27.5% Solution of Lustran® 29 dissolved in Methyl Methacrylate) 146.7 g
TRIM (Trimethylolpropane Trimethacrylate; SR-350 from Sartomer) 4.62 g
A-174 (γ-Methacryloxypropyl Trimethoxysilane; Silquest® A-174 from Momentive) 4.62 g
Tinuvin® P (2-(2H-benzotriazol-2-yl)-p-Cresol from BASF) 0.34 g
Toluidine (N,N-Bis(2-hydroxyethyl)-p-Toluidine from Sigma-Aldrich) 0.57 g

The mixture was stirred using a four-blade stainless steel propeller (60 mm diameter with four 30° pitched blades) at 1200 rpm for about one minute. A pre-mixed blend of 68.2 g Aluminum Trihydroxide (Chalco H-WF-75 ATH) and 2.27 g fumed silica (Cab-O-Sil® TS-720 from Cabot) was then added portion wise over a one minute interval. After the addition of the ATH/fumed silica blend is complete, mixing was continued for an additional 2-3 minutes. The mixture was slowly evacuated (Reflux condenser cooled to −10 deg C.) to 75 Torr (about 27 inches of Hg) over one minute with continued stirring at ˜1200 rpm. The vacuum was released with air and approximately a 125 g aliquot was withdrawn for measurement of Brookfield Viscosity. The Brookfield Viscosity (RVDVI-Prime; vane spindle #73; at 25° C.) was 21,400 cps at 1 rpm and 13,460 cps at 10 rpm. The thixo ratio (cps @ 1 rpm/10 rpm) was calculated as 1.6.

Preparation of Component B—

A 500 mL reaction kettle (˜10 cm×15 cm) having a ground glass fitting was assembled with a reaction kettle top (with a ground glass fitting) having ports for an air-driven mechanical stirrer and an Allihn® type reflux condenser. The following ingredients were sequentially weighed into the reaction kettle:
DPGDB (Dipropyleneglycol Dibenzoate from Sigma-Aldrich) 25.6 g
Luperox® A98 (75% Dibenzoyl Peroxide in Water from Arkema) 0.91 g
TS-720 (Cab-O-Sil® TS-720 fumed silica from Cabot) 0.82 g

The above mixture was stirred using a four-blade stainless steel propeller (60 mm diameter with four 30° pitched blades) at 1200 rpm for about one minute. The mixture was slowly evacuated (Reflux condenser cooled to −10 deg C.) to 75 Torr (about 27 inches of Hg) over one minute with continued stirring at ˜1200 rpm. The vacuum was released with air and a 125 g aliquot was withdrawn for measurement of Brookfield Viscosity. The Brookfield Viscosity (RVDVI-Prime; vane spindle #73; at 25° C.) was 69,000 cps at 1 rpm and 9,580 cps at 10 rpm. The thixo ratio (cps@1 rpm/cps@10 rpm) was calculated as ˜7.2.

Preparation of Two-Part Adhesive—

Component A (227.3 g) was charged to a small disposable plastic cup (PE, 16 oz). Component B (22.7 g) was added in a weight ratio of about 1:10 and the resulting mixture was gently mixed with a wooden tongue depressor. Prior to dispensing the adhesive mixture into the test joint, the adhesive containing components A and B was slowly evacuated (Reflux condenser cooled to −10 deg C.) to 75 Torr (about 27 inches of Hg) over one minute with continued stirring at ˜1200 rpm by placing the disposable plastic cup inside of a 500 mL reaction kettle.

Preparation of an Adhesive Butt Joint for Mechanical Testing—

Corian® Bisque solid surface sheet (from DuPont) was used as the substrate (adherend) for butt joint uniaxial tensile testing. The butt joint was prepared using the protocol as outlined in ASTM D1002. The adherend was prepared according to ASTM D2093 using 150 grit sandpaper followed by a methanol solvent wipe. Following procedures outlined in D1002, an adhesive test panel was prepared by aligning two pieces of Corian® Bisque material (280 mm×114 mm×12 mm) side-by-side with approximately a 6-10 mm gap between them. The open gap was fitted with a 10 mil spacer in order to uniformly control the gap width of the adhesive joint. The gap was also fitted with a 10 mil twisted pair J-type thermocouple in order to measure the set time of the adhesive butt joint. The de-gassed adhesive was dispensed within the gap and the two pieces of Corian® are moved together, clamped and held in place for about 30-60 minutes or until adequate handling strength was developed by the test panel. The adherend was conditioned at 140° C. for one hour and then cut into six narrow tensile test specimens. The rectangular test specimens were then milled into tensile bars according to ASTM D638. The set time of the adhesive butt joint was measured at 28.4 minutes using the time-temperature data provided by the thermocouple embedded within the adhesive joint. The tensile strength (Ultimate Stress) of the butt joint was 42.3 MPa with a tensile elongation (Ultimate Strain) of 0.57%. The modulus was measured as 9.5 GPa. The tensile strength of Corian® Bisque solid surface material without any joint is known to be about 48 MPa with a tensile elongation of about 0.95%.

Preparation of a Bulk Adhesive Test Specimen for Color and Hardness Testing—

The remaining adhesive that was not used to prepare the butt joint was poured into a small mold (75 mm×75 mm×18 mm) equipped with a J-Type thermocouple and allowed to cure. The time-to-peak for the adhesive puck was 17.1 minutes and the small casting reached a peak temperature of 142° C. The indentation hardness (Rockwell M Scale) was measured as 60. The CIE color was measured as L*=88.0, a*=−2.59, and b*=−1.23 using a Hunter MiniScan® EZ.

This example demonstrates that a joint adhesive with superior strength and elongation can be prepared using ATH with a larger particle size. The example (together with the 15 micron example) show that the preferred filler has a particle size less than about 9 microns in that there is a minor drop in joint strength when the fillers with greater than 9 microns are used (e.g. 15 and 75 micron ATH fillers).

### Example 5

### Two Part (10:1) Semi-IPN Joint Adhesive (3 Micron ATH Filler) Styrene/Acrylonitrile Copolymer (SAN) Based Component a with Dibenzoyl Peroxide (BPO) Based Component B

Preparation of Component A—

A 500 mL reaction kettle (˜10 cm×15 cm) having a ground glass fitting is assembled with a reaction kettle top (with a ground glass fitting) having ports for an air-driven mechanical stirrer and an Allihn® type reflux condenser. The following ingredients were sequentially weighed into the reaction kettle:
Prepolymer Sirup (27.5% Solution of Lustran® 29 dissolved in Methyl Methacrylate) 172 g
TRIM (Trimethylolpropane Trimethacrylate; SR-350 from Sartomer) 5.42 g
A-174 (γ-Methacryloxypropyl Trimethoxysilane; Silquest® A-174 from Momentive) 5.42 g
Tinuvin® P (2-(2H-benzotriazol-2-yl)-p-Cresol from BASF) 0.40 g
Toluidine (N,N-Bis(2-hydroxyethyl)-p-Toluidine from Sigma-Aldrich) 0.67 g

The mixture was mechanically stirred using a four-blade stainless steel propeller (60 mm diameter with four 30° pitched blades) at 1200 rpm for about one minute. A pre-mixed blend of 79.9 g Aluminum Trihydroxide (Huber Micral® 632 ATH) and 2.66 g fumed silica (Cab-O-Sil® TS-720 from Cabot) was then added portion wise over a one minute interval. After the addition of the ATH/fumed silica blend was complete, mixing continued for an additional 2-3 minutes. The mixture was slowly degassed (Reflux condenser cooled to −10 deg C.) to 75 Torr (about 27 inches of Hg) over one minute with continued stirring at ˜1200 rpm. The vacuum was released with air and approximately a 125 g aliquot was withdrawn for measurement of Brookfield Viscosity. The Brookfield Viscosity (RVDVI-Prime; vane spindle #73; at 25° C.) was 48,150 cps at 1 rpm and 18,620 cps at 10 rpm. The thixo ratio (cps @ 1 rpm/10 rpm) was calculated as ˜2.6.

Preparation of Component B—

A 500 mL reaction kettle (˜10 cm×15 cm) having a ground glass fitting was assembled with a reaction kettle top (with a ground glass fitting) having ports for an air-driven mechanical stirrer and an Allihn® type reflux condenser. The following ingredients were sequentially weighed into the reaction kettle:
DPGDB (Dipropyleneglycol Dibenzoate from Sigma-Aldrich) 25.6 g
Luperox® A98 (75% Dibenzoyl Peroxide in Water from Arkema) 0.91 g
TS-720 (Cab-O-Sil® TS-720 fumed silica from Cabot) 0.82 g

The above mixture was mechanically stirred using a four-blade stainless steel propeller (60 mm diameter with four 30° pitched blades) at 1200 rpm for about one minute. The mixture was slowly degassed (Reflux condenser cooled to −10 deg C.) to 75 Torr (about 27 inches of Hg) over one minute with continued stirring at ˜1200 rpm. The vacuum was released with air and a 125 g aliquot was withdrawn for measurement of Brookfield Viscosity. The Brookfield Viscosity (RVDVI-Prime; vane spindle #73; at 250 C) was 69,000 cps at 1 rpm and 9,580 cps at 10 rpm. The thixo ratio (cps@1 rpm/cps@10 rpm) was calculated as ˜7.2.

Preparation of Two-Part Adhesive—

Component A (266.4 g) was charged to a small disposable plastic cup (PE, 16 oz). Component B (25.3 g) was added in a volume ratio of about 1:10 (one part component B to 10 parts component A) and the resulting mixture was gently stirred with a wooden tongue depressor. Prior to dispensing the adhesive mixture into a test joint, the adhesive mixture containing both components A and B was slowly degassed (Reflux condenser cooled to −10 deg C.) to 75 Torr (about 27 inches of Hg) over one minute with continued stirring at −1200 rpm by placing the disposable plastic cup inside of a 500 mL reaction kettle.

Preparation of an Adhesive Butt Joint for Mechanical Testing—

Corian® Bisque solid surface sheet (from DuPont) was used as the substrate (adherend) for preparing a simple butt joint for uniaxial tensile testing. The butt joint was prepared using the protocol as outlined in ASTM D1002. The adherend was prepared according to ASTM D2093 using 150 grit sandpaper followed by a methanol solvent wipe. Following procedures outlined in D1002, an adhesive test panel is prepared by aligning the two pieces of Corian® Bisque material (280 mm×114 mm×12 mm) side-by-side with approximately a 6-10 mm gap between them. The open gap was fitted with a 10 mil spacer in order to uniformly control the gap width of the adhesive joint. The gap was also fitted with a 10 mil twisted pair J-type thermocouple in order to measure the set time of the adhesive butt joint. The de-gassed adhesive was dispensed within the gap and the two pieces of Corian® were moved together, clamped and held in place for about 30 minutes (until adequate handling strength is developed). The adherend was conditioned at 140° C. for one hour and then cut into six narrow tensile test specimens. The rectangular test specimens were then milled into tensile bars according to ASTM D638. The set time of the adhesive butt joint was measured as 29.7 minutes using the time-temperature data provided by the thermocouple embedded within the adhesive joint. The adhesive joint attained a peak temperature of about 37° C. The tensile strength (Ultimate Stress) of the butt joint was 47.5 MPa with a tensile elongation (Ultimate Strain) of 0.91%. The modulus was measured as 9.3 GPa. The tensile strength of Corian® Bisque solid surface material without any joint is known to be about 48 MPa with a tensile elongation of about 0.95%.

Preparation of a Bulk Adhesive Test Specimen for Color and Hardness Testing—

The remaining adhesive that was not used to prepare the butt joint was poured into a small mold (75 mm×75 mm×18 mm) equipped with a J-Type thermocouple and allowed to cure. The time-to-peak for the adhesive puck was 16.8 minutes and the small casting reached a peak temperature of 137° C. The indentation hardness (Rockwell M Scale) was measured as 43. The CIE color was measured as L*=83.0, a*=1.26, and b*=4.42 using a Hunter MiniScan® EZ.

This example shows that ATH fillers with smaller particle sizes (with correspondingly higher surface areas) can be used to prepare joint adhesive with superior strength and elongation and with acceptable fluid characteristics. The example also demonstrates how the base color of the filler and have an influence on the color and aesthetic appearance of the joint.

### Example 6

### Two Part (10:1) Semi-IPN Joint Adhesive (Zeeosphere Filled) Styrene/Acrylonitrile Copolymer (SAN) Based Component a with Dibenzoyl Peroxide (BPO) Based Component B

Preparation of Component A—

A 500 mL reaction kettle (˜10 cm×15 cm) having a ground glass fitting is assembled with a reaction kettle top (with a ground glass fitting) having ports for an air-driven mechanical stirrer and an Allihn® type reflux condenser. The following ingredients are sequentially weighed into the reaction kettle:
Prepolymer Sirup (27.5% Solution of Lustran® 29 dissolved in Methyl Methacrylate) 147 g
TRIM (Trimethylolpropane Trimethacrylate; SR-350 from Sartomer) 4.64 g
A-174 (γ-Methacryloxypropyl Trimethoxysilane; Silquest® A-174 from Momentive) 4.64 g
Tinuvin® P (2-(2H-benzotriazol-2-yl)-p-Cresol from BASF) 0.34 g
Toluidine (N,N-Bis(2-hydroxyethyl)-p-Toluidine from Sigma-Aldrich) 0.57 g

The mixture is mechanically stirred using a four-blade stainless steel propeller (60 mm diameter with four 300 pitched blades) at 1200 rpm for about one minute. A pre-mixed blend of 68.5 g of white ceramic microspheres (3M™ Zeeospheres W-410) and 1.0 g fumed silica (Cab-O-Sil® TS-720 from Cabot) is then added portion wise over a one minute interval. After the addition of the Zeeosphere/fumed silica blend is complete, mixing is continued for an additional 2-3 minutes. The mixture is slowly degassed (Reflux condenser cooled to −10□C) to 75 Torr (about 27 inches of Hg) over one minute with continued stirring at ˜1200 rpm. The vacuum is released with air and approximately a 125 g aliquot is withdrawn for measurement of Brookfield Viscosity. The Brookfield Viscosity (RVDVI-Prime; vane spindle #73; at 250 C) is 39,060 cps at 1 rpm and 17,040 cps at 10 rpm. The thixo ratio (cps @ 1 rpm/10 rpm) is calculated as ˜2.3.

Preparation of Component B—

A 500 mL reaction kettle (˜10 cm×15 cm) having a ground glass fitting is assembled with a reaction kettle top (with a ground glass fitting) having ports for an air-driven mechanical stirrer and an Allihn® type reflux condenser. The following ingredients are sequentially weighed into the reaction kettle:
DPGDB (Dipropyleneglycol Dibenzoate from Sigma-Aldrich) 25.6 g
Luperox® A98 (75% Dibenzoyl Peroxide in Water from Arkema) 0.91 g
TS-720 (Cab-O-Sil® TS-720 fumed silica from Cabot) 0.82 g

The above mixture is mechanically stirred using a four-blade stainless steel propeller (60 mm diameter with four 300 pitched blades) at 1200 rpm for about one minute. The mixture is slowly degassed (Reflux condenser cooled to −10□C) to 75 Torr (about 27 inches of Hg) over one minute with continued stirring at −1200 rpm. The vacuum was released with air and a 125 g aliquot was withdrawn for measurement of Brookfield Viscosity. The Brookfield Viscosity (RVDVI-Prime; vane spindle #73; at 250 C) is 69,000 cps at 1 rpm and 9,580 cps at 10 rpm. The thixo ratio (cps@1 rpm/cps@10 rpm) is calculated as ˜7.2.

Preparation of Two-Part Adhesive—

Component A (228.3 g) is charged to a small disposable plastic cup (PE, 16 oz). Component B (21.7 g) is added in a volume ratio of about 1:10 (one part component B to 10 parts component A) and the resulting mixture is gently stirred with a wooden tongue depressor. Prior to dispensing the adhesive mixture into a test joint, the adhesive mixture containing both components A and B is slowly degassed (Reflux condenser cooled to −10□C) to 75 Torr (about 27 inches of Hg) over one minute with continued stirring at ˜1200 rpm by placing the disposable plastic cup inside of a 500 mL reaction kettle.

Preparation of an Adhesive Butt Joint for Mechanical Testing—Corian® Bisque (DuPont) was used as the substrate (adherend) for preparing a simple butt joint for uniaxial tensile testing. The butt joint was prepared using the protocol as outlined in ASTM D1002. The Corian® surface was prepared according to ASTM D2093 using 150 grit sandpaper followed by a methanol solvent wipe. Following procedures outlined in D1002, an adhesive test panel is prepared by aligning two pieces of Corian® Bisque material (280 mm×114 mm×12 mm) side-by-side with approximately a 6-10 mm gap between them. The open gap was fitted with a 10 mil spacer in order to uniformly control the gap width of the adhesive joint. The gap was also fitted with a 10 mil twisted pair J-type thermocouple in order to measure the set time of the adhesive butt joint. The de-gassed adhesive is dispensed within the gap and the two pieces of Corian® are moved together, clamped and held in place for about 30-60 minutes or until adequate handling strength is developed by the test panel. The adhesive joint test panel is conditioned at 1400 C for one hour and then cut into six narrow tensile test specimens. The rectangular test specimens are then milled into tensile bars according to ASTM D638. The set time of the adhesive butt joint was measured as 29.3 minutes using the time-temperature data provided by the thermocouple embedded within the adhesive joint. The adhesive joint attained a peak temperature of about 370 C. The tensile strength (Ultimate Stress) of the butt joint was 44.4 MPa with a tensile elongation (Ultimate Strain) of 0.72%. The modulus was measured as 9.3 GPa. The tensile strength of Corian® Bisque solid surface material without any joint is typically measured as about 48 MPa with a tensile elongation of about 0.95%.

Preparation of a Bulk Adhesive Test Specimen for Color and Hardness Testing—

The remaining adhesive that was not used to prepare the butt joint is poured into a small mold (75 mm×75 mm×18 mm) equipped with a J-Type thermocouple and allowed to cure. The time-to-peak for the adhesive puck was 16.4 minutes and the small casting reached a peak temperature of 1460 C. The indentation hardness (Rockwell M Scale) was measured as 35. The CIE color was measured as L*=79.3, a*=−0.49, and b*=0.45 using a Hunter MiniScan® EZ.

This example demonstrates that a joint adhesive with superior strength and elongation can be prepared using a ceramic microsphere as a filler as an alternative to an ATH filler.

### Example 7

### Two Part (10:1) Semi-IPN Joint Adhesive (9 Micron ATH Filled) Styrene Maleic Anhydride Copolymer (SMA) Based Component a with Dibenzoyl Peroxide (BPO) Based Component B

Preparation of Component A—

A 500 mL reaction kettle (˜10 cm×15 cm) having a ground glass fitting is assembled with a reaction kettle top (with a ground glass fitting) having ports for an air-driven mechanical stirrer and an Allihn® type reflux condenser. The following ingredients are sequentially weighed into the reaction kettle:
Prepolymer Sirup (32% Solution of Dylark® 232 dissolved in Methyl Methacrylate) 148 g
TRIM (Trimethylolpropane Trimethacrylate; SR-350 from Sartomer) 4.37 g
A-174 (γ-Methacryloxypropyl Trimethoxysilane; Silquest® A-174 from Momentive) 4.37 g
Tinuvin® P (2-(2H-benzotriazol-2-yl)-p-Cresol from BASF) 0.34 g
Toluidine (N,N-Bis(2-hydroxyethyl)-p-Toluidine from Sigma-Aldrich) 0.57 g

The mixture is stirred using a four-blade stainless steel propeller (60 mm diameter with four 300 pitched blades) at 1200 rpm for about one minute. A pre-mixed blend of 68.5 g Aluminum Trihydroxide (OE-431 ATH from Huber Engineered Materials) and 2.28 g fumed silica (Cab-O-Sil® TS-720 from Cabot) is then added portion wise over a one minute interval. After the addition of the ATH/fumed silica blend is complete, mixing is continued for an additional 2-3 minutes. The mixture is slowly evacuated (Reflux condenser cooled to −10□C) to 75 Torr (about 27 inches of Hg) over one minute with continued stirring at ˜1200 rpm. The vacuum is released with air and a 125 g aliquot is withdrawn for measurement of Brookfield Viscosity. The Brookfield Viscosity (RVDVI-Prime; vane spindle #73; at 250 C) is 26,750 cps at 1 rpm and 14,870 cps at 10 rpm. The thixo ratio (cps @ 1 rpm/10 rpm) is calculated as ˜1.8.

Preparation of Component B—

A 500 mL reaction kettle (˜10 cm×15 cm) having a ground glass fitting is assembled with a reaction kettle top (with a ground glass fitting) having ports for an air-driven mechanical stirrer and an Allihn® type reflux condenser. The following ingredients are sequentially weighed into the reaction kettle:
DPGDB (Dipropyleneglycol Dibenzoate from Sigma-Aldrich) 25.6 g
Luperox® A98 (75% Dibenzoyl Peroxide in Water from Arkema) 0.91 g
TS-720 (Cab-O-Sil® TS-720 fumed silica from Cabot) 0.82 g

The above mixture is stirred using a four-blade stainless steel propeller (60 mm diameter with four 300 pitched blades) at 1200 rpm for about one minute. The mixture is slowly evacuated (Reflux condenser cooled to −10□C) to 75 Torr (about 27 inches of Hg) over one minute with continued stirring at ˜1200 rpm. The vacuum was released with air and a 125 g aliquot was withdrawn for measurement of Brookfield Viscosity. The Brookfield Viscosity (RVDVI-Prime; vane spindle #73; at 250 C) is 69,000 cps at 1 rpm and 9,580 cps at 10 rpm. The thixo ratio (cps@1 rpm/cps@10 rpm) is calculated as ˜7.2.

Preparation of Two-Part Adhesive—Component A (228.4 g) is charged to a small disposable plastic cup (PE, 16 oz). Component B (21.6 g) is added in a volume ratio of about 10:1 and the resulting mixture is gently mixed with a wooden tongue depressor. Prior to dispensing the adhesive mixture into a test joint, the adhesive containing components A and B is slowly degassed (Reflux condenser cooled to −10□C) to 75 Torr (about 27 inches of Hg) over one minute with continued stirring at ˜1200 rpm by placing the disposable plastic cup inside of a 500 mL reaction kettle.

Preparation of an Adhesive Butt Joint for Mechanical Testing—

Corian® Bisque (DuPont) was used as the substrate (adherend) for butt joint uniaxial tensile testing. The butt joint was prepared using the general protocol as outlined in ASTM D1002. The Corian® surface was prepared according to ASTM D2093 using 150 grit sandpaper followed by a methanol solvent wipe. Following procedures outlined in D1002, an adhesive test panel is prepared by aligning two pieces of Corian® Bisque material (280 mm×114 mm×12 mm) side-by-side with approximately a 6-10 mm gap between them. The open gap was fitted with a 10 mil spacer in order to uniformly control the gap width of the adhesive joint. The gap was also fitted with a 10 mil twisted pair J-type thermocouple in order to measure the set time of the adhesive butt joint. The degassed adhesive is dispensed within the gap and the two pieces of Corian® are moved together, clamped and held in place for about 30-60 minutes or until adequate handling strength is developed by the test panel. The test panel is conditioned at 1400 C for one hour and then cut into six narrow tensile test specimens. The rectangular test specimens are then milled into tensile bars according to ASTM D638. The set time of the adhesive butt joint was measured as 31.8 minutes using the time-temperature data provided by the thermocouple embedded within the adhesive joint. The tensile strength (Ultimate Stress) of the butt joint was 46.2 MPa with a tensile elongation (Ultimate Strain) of 0.79%. The modulus was measured as 9.6 GPa. The tensile strength of Corian® Bisque is typically measured at about 48 MPa with a tensile elongation of about 0.95%.

Preparation of a Bulk Adhesive Test Specimen for Color and Hardness Testing—

The remaining adhesive that was not used to prepare the butt joint is poured into a small mold (75 mm×75 mm×18 mm) equipped with a J-Type thermocouple and allowed to cure. The time-to-peak for the adhesive puck was 16.3 minutes and the small casting reached a peak temperature of 1380 C. The indentation hardness (Rockwell M Scale) was measured at 70. The CIE color was measured as L*=93.3, a*=−1.64, and b*=+1.79 using a Hunter MiniScan® EZ.

This example demonstrates a preferred joint adhesive composition using a styrene maleic anhydride copolymer to prepare the semi-IPN both from a strength and elongation perspective but also from an aesthetic perspective.

### Summary of Data from Patent Examples

TABLE 1
Joint Adhesive Fluid Characteristics

| | | | Component A | Component A | |
|---|---|---|---|---|---|
| | | Semi- | Viscosity | Viscosity | Thixo |
| Example | Filler | IPN | 1 rpm | 10 rpm | Ratio |
| 1 | 15μ ATH | SAN | 69,000 | 9,580 | 7.2 |
| 2 | None | SAN | 42,800 | 14,230 | 3.0 |
| 3 | 9μ ATH | SAN | 20,660 | 14,460 | 1.4 |
| 4 | 75μ ATH | SAN | 21,400 | 13,640 | 1.6 |
| 5 | 3μ ATH | SAN | 48,150 | 18,620 | 2.6 |
| 6 | 4μ- | SAN | 39,060 | 17,040 | 2.3 |
| | Zeeosphere | | | | |
| 7 | 9μ ATH | SMA | 26,750 | 14,870 | 1.8 |
| DJA-TW | ~15μ ATH | | 31,570 | 29,480 | 1.1 |
| Control | | | | | |

The data summarized in Table 1 demonstrates that a a flowable adhesive composition with fluid viscosity appropriate for use as an polymerizable adhesive for joining solid surface materials can be prepared using a range of ATH fillers with varying particle sizes.

TABLE 2
Joint Adhesive Tensile Properties

| | | Semi- | | | |
|---|---|---|---|---|---|
| Example | Filler | IPN | Strength | Elongation | Modulus |
| 1 | 15μ ATH | SAN | 42.0 | 0.61 | 9.2 |
| 2 | None | SAN | 45.9 | 0.74 | 8.9 |
| 3 | 9μ ATH | SAN | 47.7 | 0.82 | 9.2 |
| 4 | 75μ ATH | SAN | 42.3 | 0.57 | 9.5 |
| 5 | 3μ ATH | SAN | 47.5 | 0.91 | 9.3 |
| 6 | 4μ- | SAN | 44.4 | 0.72 | 9.3 |
| | Zeeosphere | | | | |
| 7 | 9μ ATH | SMA | 46.2 | 0.79 | 9.6 |
| DJA-TW | ~15μ ATH | | 29.8 | 0.36 | 9.4 |
| Control | | | | | |

The data summarized in Table 2 demonstrates the superior mechanical properties of the polymerizable adhesive composition that forms an IPN as compared to a control commercial formulation.

TABLE 3

| | | | Joint Adhesive Cure | | | |
|---|---|---|---|---|---|---|
| | | | Characteristics | | | |
| | | | Joint | Puck | Puck | |
| | | | Set | Set | Max | Puck |
| Example | Filler | Semi-IPN | Time | Time | Temp | Hardness |
| 1 | 15μ ATH | SAN | 28.0 | 17.3 | 140 | 51 |
| 2 | None | SAN | 35.5 | 19.1 | 146 | 46 |
| 3 | 9μ ATH | SAN | 19.0 | 12.7 | 135 | 60 |
| 4 | 75μ ATH | SAN | 28.4 | 17.1 | 142 | 60 |
| 5 | 3μ ATH | SAN | 29.7 | 16.8 | 137 | 43 |
| 6 | 4μ-Zeeosphere | SAN | 29.3 | 16.4 | 146 | 35 |
| 7 | 9μ ATH | SMA | 31.8 | 16.3 | 138 | 70 |
| DJA-TW | ~15μ ATH | | 18.0 | 12.9 | 139 | 55 |
| Control | | | | | | |

The data summarized in Table 3 demonstrates that the cure characteristics of the polymerizable adhesive composition that forms an IPN are similar to a control commercial formulation.

TABLE 4
Joint Adhesive Puck Color Measurements

| | | Semi- | | | |
|---|---|---|---|---|---|
| Example | Filler | IPN | L* | a* | b* |
| 1 | 15μ ATH | SAN | 89.2 | −1.60 | −0.79 |
| 2 | None | SAN | 90.0 | −1.50 | −2.50 |
| 3 | 9μ ATH | SAN | 89.1 | −1.39 | −0.43 |
| 4 | 75μ ATH | SAN | 88.0 | −2.59 | −1.23 |
| 5 | 3μ ATH | SAN | 83.0 | 1.26 | +4.42 |
| 6 | 4μ- | SAN | 79.3 | −0.49 | +0.45 |
| | Zeeosphere | | | | |
| 7 | 9μ ATH | SMA | 93.3 | −1.64 | +1.79 |
| DJA-TW | ~15μ ATH | | 83.9 | −2.40 | +7.10 |
| Control | | | | | |

The data summarized in Table 4 demonstrates the color characteristics of the polymerizable adhesive compositions that form an IPN are similar to a control commercial formulation and that the color characteristics would have acceptable aesthetics and appearance when used for joining solid surface materials.

What is claimed is:

1. A polymerizable adhesive comprising a styrene acrylonitrile copolymer, a (meth)acrylate monomer, and a multifunctional (meth)acrylate crosslinking agent wherein an interpenetrating network is formed when the components are polymerized.

2. The polymerizable adhesive of claim 1 wherein the (meth)acrylate monomer is methyl methacrylate.

3. The polymerizable adhesive of claim 2 wherein the multifunctional (meth)acrylate crosslinking agent is trimethylolpropane trimethacrylate.

4. The polymerizable adhesive of claim 3 also comprising a filler selected from the group of alumina trihydrate (ATH), glass microspheres, ceramic microspheres, or combinations thereof.

5. The polymerizable adhesive of claim 4 also comprising an adhesion-promoting (meth)acrylate monomer.

6. A polymerizable adhesive comprising a styrene maleic anhydride (SMA) copolymer, a (meth)acrylate monomer, and a multifunctional (meth)acrylate crosslinking agent wherein an interpenetrating network is formed when the components are polymerized.

7. The polymerizable adhesive of claim 5 wherein the (meth)acrylate monomer is methyl methacrylate.

8. The polymerizable adhesive of claim 6 wherein the multifunctional (meth)acrylate crosslinking agent is trimethylolpropane trimethacrylate.

9. The polymerizable adhesive of claim 7 also comprising a filler selected from the group of alumina trihydrate (ATH), glass microspheres, ceramic microspheres, or combinations thereof.

10. The polymerizable adhesive of claim 9 also comprising an adhesion-promoting (meth)acrylate monomer.
